(19) United States
(12) Patent Application Publication
(10) Pub. No.: US 2021/0341354 A1
(43) Pub. Date: Nov. 4, 2021

(54) DEVICE AND METHOD FOR INSPECTING SENSOR SYSTEM

(71) Applicant: KOITO MANUFACTURING CO., LTD., Tokyo (JP)

(72) Inventors: Shigeyuki WATANABE, Shizuoka-shi, Shizuoka (JP); Yuichi WATANO, Shizuoka-shi, Shizuoka (JP); Shunsuke OKAMURA, Shizuoka-shi, Shizuoka (JP)

(73) Assignee: KOITO MANUFACTURING CO., LTD., Tokyo (JP)

(21) Appl. No.: 17/260,485

(22) PCT Filed: Jul. 11, 2019
(86) PCT No.: PCT/JP2019/027545

§ 371 Date: Jan. 14, 2021

(30) Foreign Application Priority Data
Jul. 18, 2018 (JP) 2018-134898

(51) Int. Cl. G01M 11/02; G01S 7/481; G01S 17/931

(52) U.S. Cl. CPC G01M 11/0278; G01S 7/4817; G01S 7/4814; G01S 7/4811; G01S 17/931

(57) ABSTRACT

A sensor system (100) is equipped with a light emitting element that emits detecting light (L1), a translucent cover (120) that allows passage of the detecting light (L1), and a scanning mechanism that changes an emitting direction of the detecting light (L1) at least in a first direction (D1). A light receiving device (210) is equipped with a plurality of inspection light receiving elements (211a to 211g) arranged at least along the first direction, and adapted to be disposed on an optical path of the detecting light (L1) that has passed through the translucent cover (120). An inspection processor (220) is configured to output a determination result (R) as to whether an abnormality is present in the translucent cover (120) on the basis of a determination as to whether each of the inspection light receiving elements (211a to 211g) has normally received the detecting light (L).

### FIELD

The presently disclosed subject matter relates to an inspection device and an inspection method for a sensor system.

### BACKGROUND

Patent Document 1 discloses a sensor system adapted to be installed in a vehicle. The sensor system uses a LiDAR (Light Detecting and Ranging) sensor. The LiDAR sensor includes a light emitting element and a light receiving element. The light emitting element emits detecting light toward an outside area of the vehicle. The detecting light is reflected by an object that situates in the outside area of the vehicle, and incident on the light receiving element as reflected light. For example, the distance to the object that generates the reflected light can be detected based on the time period from the time when the detecting light is emitted from the light emitting element to the time when the reflected light is incident on the light receiving element.

### CITATION LIST

### Patent Document

Patent Document 1: Japanese Patent Publication No. 2018-049014 A

### SUMMARY

### Technical Problem

The light emitting element and the light receiving element are covered with a translucent cover. Accordingly, the detecting light and the reflected light pass through the translucent cover. For example, when a portion of the translucent cover is scratched or deformed, the detecting light passing through the portion may be abnormally refracted and deviated from the original traveling direction. In this case, it is impossible to detect the information of an object that situates on the original traveling direction, so that the information detecting accuracy of the sensor system is degraded.

Accordingly, it is demanded to suppress degradation in the information detecting accuracy of the sensor system when an abnormality occurs in the translucent cover through which the detecting light emitted from the light emitting element passes.

### Solution to Problem

In order to meet the demand described above, one illustrative aspect of the presently disclosed subject matter provides an inspection device for a sensor system equipped with a light emitting element that emits detecting light, a translucent cover that allows passage of the detecting light, and a scanning mechanism that changes an emitting direction of the detecting light at least in a first direction, the inspection device comprising:

a light receiving device equipped with a plurality of inspection light receiving elements arranged at least along the first direction, and adapted to be disposed on an optical path of the detecting light that has passed through the translucent cover; and

a processor configured to output a determination result as to whether an abnormality is present in the translucent cover on the basis of a determination as to whether each of the inspection light receiving elements has normally received the detecting light.

In order to meet the demand described above, one illustrative aspect of the presently disclosed subject matter provides inspection method for a sensor system equipped with a light emitting element that emits detecting light, a translucent cover that allows passage of the detecting light, and a scanning mechanism that changes an emitting direction of the detecting light at least in a first direction, the inspection method comprising:

disposing a light receiving device equipped with a plurality of inspection light receiving elements arranged at least along the first direction on an optical path of the detecting light that has passed through the translucent cover;

causing the light emitting element to emit the detecting light;

causing the scanning mechanism to scan the detecting light at least in the first direction; and

outputting a determination result as to whether an abnormality is present in the translucent cover on the basis of a determination as to whether each of the inspection light receiving elements has normally received the detecting light.

According to the inspection device and the inspection method as described above, it is possible to detect the presence or absence of an abnormality in the translucent cover by a simple method of disposing the light receiving device on the optical path of the detecting light passing through the translucent cover and causing the sensor system to execute the detecting operation. When an abnormality is detected in the translucent cover, appropriate measures such as replacement and repair can be taken. Accordingly, it is possible to suppress degradation in the information detecting accuracy of the sensor system.

The above inspection device may be configured such that the processor is configured to output the determination result on the basis of a relationship between the emitting direction of the detecting, light and a position where the detecting light is received at the light receiving device.

According to such a configuration, the determination result may include more detailed information. For example, it may include information as to how the path of the detecting light, which was originally to be incident on a specific inspection light receiving element, was changed by an abnormality of the translucent cover.

In this case, the above inspection device may be configured such that the processor is configured to, in a case where none of the inspection light receiving elements receives the detecting light emitted toward one of the inspection light receiving elements, cause the light emitting element to emit the detecting light again after a position of the light receiving device is changed.

According to such a configuration, even in a case where the traveling direction of the detecting light refracted by the abnormality of the translucent cover extends over a wider range, it is possible to obtain information as to the abnormality of the translucent cover.

In this case, the above inspection device may be configured such that the processor is configured to, in a case where the determination result indicates that an abnormality is present in the translucent cover, output data for correcting a detected result obtained by the sensor system.

According to such a configuration, even when an abnormality is detected in the translucent cover that allows the passage of the detecting light emitted from the light emitting element, it is possible to suppress degradation in the information detecting accuracy of the sensor system without replacing or repairing the translucent cover.

The above inspection device may be configured such that the inspection light receiving elements are arranged two-dimensionally.

According to such a configuration, even in a case where the traveling direction of the detecting light refracted by the abnormality of the translucent cover extends over a wider range, it is easy to obtain information on the abnormality of the translucent cover. In addition, it is also possible to easily cope with a sensor system in which detecting light is scanned two-dimensionally.

As used herein, the term “light” means an electromagnetic wave having an arbitrary wavelength capable of detecting desired information. For example, the term “light” as used herein includes not only visible light but also ultraviolet light, infrared light, millimeter waves, and microwaves.

### BRIEF DESCRIPTION OF DRAWINGS

FIG. 1 illustrates a configuration of a sensor system to be inspected by an inspection device.

FIG. 2 illustrates a configuration of an inspection device according to an embodiment.

FIG. 3 illustrates a flow chart illustrating an inspection method performed with the inspection device of FIG. 2.

FIG. 4A illustrates an inspection method performed with the inspection device of FIG. 2.

FIG. 4B illustrates an inspection method performed with the inspection device of FIG. 2.

FIG. 4C illustrates another configuration of the inspection device of FIG. 2.

### DESCRIPTION OF EMBODIMENTS

Examples of embodiments will be described below in detail with reference to the accompanying drawings. In each of the drawings used in the following description, the scale is appropriately changed in order to make each member have a recognizable size.

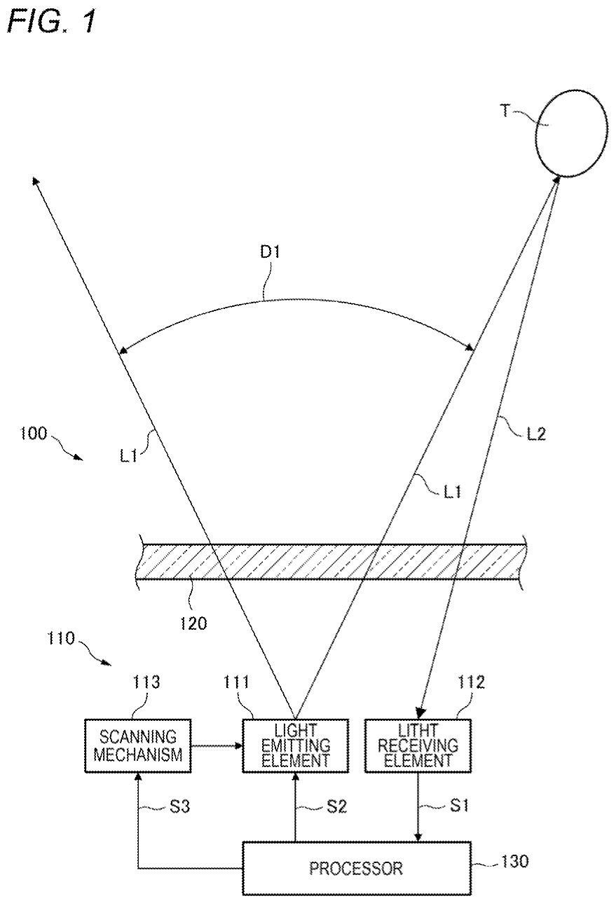

FIG. 1 illustrates a configuration of a sensor system 100 to be inspected by an inspection device according to an embodiment. The sensor system 100 includes a LiDAR sensor unit 110 and a translucent cover 120. The sensor system 100 is installed in, for example, a vehicle. In this case, the LiDAR sensor unit 110 detects information in an outside area of the vehicle for the driving support. The translucent cover 120 forms a part of an outer surface of the vehicle.

As used herein, the term “sensor unit” means a constituent unit of a component that can be distributed by itself as a single unit while providing a desired information detecting function.

As used herein, the term “driving support” means control processing that at least partially performs at least one of driving operation (steering operation, acceleration, deceleration), monitoring of a driving environment, and backup of driving operation. That is, it includes not only the partial driving support such as braking function for collision avoidance and assisting function for lane-keeping, but also a full self-driving operation.

The LiDAR sensor unit 110 includes a light emitting element 111, a light receiving element 112, and a scanning mechanism 113. The translucent cover 120 covers at least the light emitting element 111 and the light receiving element 112.

The light emitting element 111 is configured to emit detecting light L1. As the detecting light L1, for example, infrared light having a wavelength of 905 nm can be used. As the light emitting element 111, a semiconductor light emitting element such as a laser diode or a light emitting diode can be used.

The detecting light L1 emitted from the light emitting element 111 passes through the translucent cover 120. The detecting light L1 is reflected by an object T that situates outside the translucent cover 120, passes through the translucent cover 120 again as reflected light L2, and is received by the light receiving element 112.

The light receiving element 112 is configured to output a light receiving signal S1 corresponding to the amount of incident light. As the light receiving element 112, a photodiode, a phototransistor, a photo resistor, or the like can be used. The LiDAR sensor unit 110 may include an amplifier circuit (not illustrated) for amplifying the light receiving signal S1.

The scanning mechanism 113 changes the emitting direction of the detecting light L1 in the first direction D1. The first direction D1 is, for example, a direction intersecting with the up-down direction of the vehicle. The movable range of the detecting light L1 defines a detecting area outside the translucent cover 12. As the detecting light L1 is displaced along the first direction D1, the detecting area is scanned.

The scanning mechanism 113 may be implemented by various well-known techniques. For example, the emitting direction of the detecting light L1 can be directly changed by displacing a support supporting the emitting element 111 with a MEMS (Micro Electro Mechanical Systems) mechanism. Alternatively, the emitting direction of the detecting light L1 can be indirectly changed by reflecting the detecting light L1 emitted from a fixed light emitting element 111 with a rotary optical system such as a polygon mirror or a rotary blade.

The sensor system 100 includes a processor 130. The functions of the processor 130 described later may be realized by a general-purpose microprocessor operating in cooperation with a memory, or may be realized by a dedicated integrated circuit such as a microcontroller, an FPGA, and an ASIC.

The processor 130 may be disposed at any position in the vehicle. The processor 130 may be provided as a part of a main ECU responsible for central control processing in the vehicle, or may be provided as a part of a sub-ECU interposed between the main ECU and the LiDAR sensor unit 110. Alternatively, the processor 130 may be incorporated in the LiDAR sensor unit 110.

The processor 130 outputs a control signal S2 for causing the light emitting element 111 to emit the detecting light L1 at a desired timing. In addition, the processor 130 outputs a control signal S3 to the scanning mechanism 113 to change the emitting direction of the detecting light L1 in the first direction D1. The processor 130 receives the light receiving signal S1 outputted from the light receiving element 112.

The processor 130 calculates the distance to the object T that generates the reflected light L2 based on the time period from the time when the detecting light L1 is emitted from the light emitting element 111 to the time when the reflected light L2 is incident on the light receiving element 112. By accumulating the data related to the calculated distance in association with the emitting direction of the detecting light L1 changed by the scanning mechanism 113, it is possible to obtain information related to the shape of the object T associated with the reflected light L2.

Additionally or alternatively, the processor 130 can obtain information as to an attribute such as the material of the object associated with the reflected light L2 based on the difference in waveforms of the detecting light L1 and the reflected light L2. By accumulating the data relating to the difference in waveforms in association with the emitting direction of the detecting light L1 changed by the scanning mechanism 113, it is possible to obtain information relating to the surface state of the object T associated with the reflected light L2.

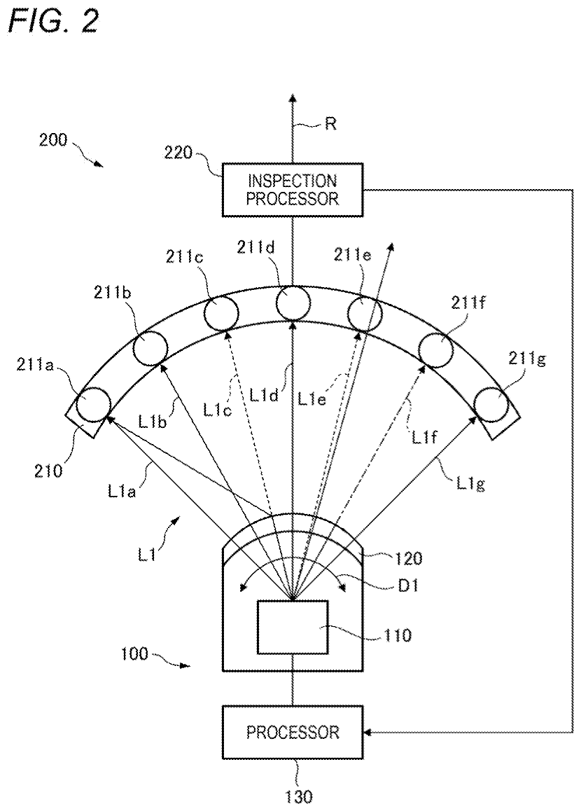

FIG. 2 illustrates a configuration of an inspection device 200 for inspecting the sensor system 100 configured as described above. The inspection device 200 includes a light receiving device 210 and an inspection processor 220.

The light receiving device 210 includes a plurality of inspection light receiving elements. In this example, the light receiving device 210 includes seven inspection light receiving elements 211a to 211g. The inspection light receiving elements 211a to 211g are arranged along the first direction D1. The number of the inspection light receiving elements can be appropriately determined according to the resolution in the first direction D1 of the LiDAR sensor unit 110.

Each of the inspection light receiving elements 211a to 211g is disposed on the optical path of the detecting light L1 that has passed through the translucent cover 120. Each of the inspection light receiving elements 211a to 211g is configured to output a light receiving signal corresponding to the amount of incident light. As each of the inspection light receiving elements 211a to 211g, a photodiode, a phototransistor, a photo resistor, or the like can be used. Each of the inspection light receiving elements 211a to 211g preferably has the same specification as the light receiving element 112 of the LiDAR sensor unit 110.

The light receiving signal outputted from each of the inspection light receiving elements 211a to 211g is inputted to the inspection processor 220. The inspection processor 220 determines whether or not each of the inspection light receiving elements 211a to 211g has normally received the detecting light L1 based on the light receiving signal outputted from each of the inspection light receiving elements 211a to 211g.

In the illustrated example, the detecting light L1 emitted in the direction indicated by the symbol L1a passes through the translucent cover 120 and is normally incident on the inspection light receiving element 211a. Accordingly, the inspection processor 220 determines that the inspection light receiving element 211a has normally received the detecting light L1.

Similarly, the detecting light L1 emitted in the direction indicated by the symbol L1b passes through the translucent cover 120 and is normally incident on the inspection light receiving element 211b. Accordingly, the inspection processor 220 determines that the inspection light receiving element 211b has normally received the detecting light L1.

The detecting light L1 emitted in the direction indicated, by the symbol L1c is incident on the inspection light receiving element 211c when it normally passes through the translucent cover 120, as indicated by the dashed lines. However, in this example, the detecting light L1 is abnormally refracted due to scratches or deformation in the translucent cover 120, and is incident on the inspection light receiving element 211a. In this case, the inspection processor 220 determines that the inspection light receiving element 211c has not normally received the detecting light L1.

The detecting light L1 emitted in the direction indicated by the symbol L1d passes through the translucent cover 120 and is normally incident on the inspection light receiving element 211d. Accordingly, the inspection processor 220 determines that the inspection light receiving element 211d has normally received the detecting light L1.

The detecting light L1 emitted in the direction indicated by the symbol L1e is incident on the inspection light receiving element 211e when it normally passes through the translucent cover 120, as indicated by the dashed lines. However, in this example, the detecting light L1 is abnormally refracted due to scratches or deformation in the translucent cover 120, and passes over the inspection light receiving element 211e. In this case, the inspection processor 220 determines that the inspection light receiving element 211e has not normally received the detecting light L1.

The detecting light L1 emitted in the direction indicated by the symbol L1f passes through the translucent cover 120 and is incident on the inspection light receiving element 211f. However, in this example, as indicated by the chain lines, the amount of light of the detecting light L1 is reduced due to scratches or deformation of the translucent cover 120. Accordingly, the inspection processor 220 determines that the inspection light receiving element 211f has not normally received the detecting light L1.

The detecting light L1 emitted in the direction indicated by the symbol L1g passes through the translucent cover 120 and is normally incident on the inspection light receiving element 211g. Accordingly, the inspection processor 220 determines that the inspection light receiving element 211g has normally received the detecting light L1.

The inspection processor 220 outputs a determination result indicating the presence or absence of an abnormality in the translucent cover 120 based on whether or not each of the inspection light receiving elements 211a to 211g has normally received the detecting light L1. The determination result R may simply indicate that there is an abnormality, or may indicate a specific abnormality. In this example, the latter determination result includes information that some abnormality is present in a portion of the translucent cover 120 through which the detecting light L1 emitted in the direction indicated by the symbol L1c passes, a portion of the translucent cover 120 through which the detecting light L1 emitted in the direction indicated by the symbol L1e passes, and a portion of the translucent cover 120 through which the detecting light L1 emitted in the direction indicated by the symbol L1f passes.

The inspection processor 220 is communicably connected to the processor 130 of the sensor system 100. The inspection processor 220 can cause the processor 130 to change the emitting direction of the detecting light L1 from the light emitting element 111 as well as the emitting direction of the detecting light L1 with the scanning mechanism 113.

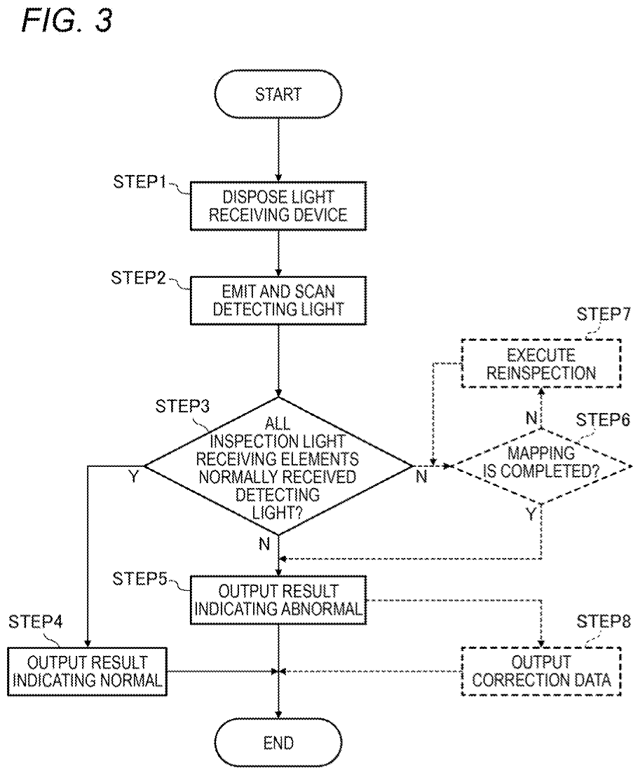

Referring to FIG. 3, a method of inspecting the sensor system 100 using the inspection device 200 configured as described above will be described.

First, the light receiving device 210 is disposed so as to face the translucent cover 120 of the sensor system 100 (STEP1). Specifically, the light receiving device 210 is disposed such that the inspection light receiving elements 211a to 211g arranged along the first direction D1 are disposed on the optical path of the detecting light L1 that has passed through the translucent cover 120.

Subsequently, the inspection processor 220 causes the processor 130 of the sensor system 100 to output the control signals S2 and S3, causes the light emitting element 111 to emit the detecting light L1, and causes the scanning mechanism 113 to change the emitting direction of the detecting light L1 in the first direction D1 (STEP2).

Next, it is determined by the inspection processor 220 whether or not all the inspection light receiving elements 211a to 211g have normally received the detecting light L1 (STEP3). The determination is made based on the level of the light receiving signal outputted from each of the inspection light receiving elements 211a to 211g.

If there is no abnormality in the translucent cover 120, the detecting light L1 scanned in the first direction D1 is sequentially incident on all the inspection light receiving elements 211a to 211g. Accordingly, a light receiving signal of a normal level is inputted from each of the inspection light receiving elements 211a to 211g to the inspection processor 220 (Y in STEP3).

In this case, the inspection processor 220 outputs a determination result R indicating that there is no abnormality in the translucent cover 120 (STEP4).

In the example illustrated in FIG. 2 described above, no light signal is outputted from the inspection light receiving element 211c and the inspection light receiving element 211e. In addition, the level of the light receiving signal outputted from the inspection light receiving element 211f is lower than the normal value. Accordingly, it is determined that normal light reception has not been performed in the inspection light receiving element 211c, the inspection light receiving element 211e, and the inspection light receiving element 211f (N in STEP3).

In this case, the inspection processor 220 outputs a determination result R indicating that there is an abnormality in the translucent cover 120 (STEP5).

According to the configuration as described above, it is possible to detect the presence or absence of an abnormality in the translucent cover 120 by a simple method of arranging the light receiving device 210 on the optical path of the detecting light L1 passing through the translucent cover 120 and causing the sensor system 100 to execute the detecting operation. When an abnormality is detected in the translucent cover 120, appropriate measures such as replacement and repair can be taken. Accordingly, it is possible to suppress degradation in the information detecting accuracy of the sensor system 100.

In the above-described method, the determination result R outputted by the inspection processor 220 may include, as information, the presence or absence of an abnormality in the translucent cover 120, or the position on the translucent cover 120 corresponding to the inspection light receiving element in which normal light reception has not been performed. However, the determination result R may include more detailed information. Specifically, it may include information as to how the path of the detecting light L1, which was originally to be incident on a specific inspection light receiving element, was changed by an abnormality of the translucent cover 120.

Since the inspection processor 220 controls the light emitting element 111 and the scanning mechanism 113 via the processor 130 of the sensor system 100, the relationship between the light emitting direction of the detecting light L1 and the light receiving position of the detecting light L1 in the light receiving device 210 can be held in advance. For example, when the detecting light L1 is emitted in the direction indicated by the symbol L1a, the correspondence that the light is received by the inspection light receiving element 211a is held by the inspection processor 220.

The inspection processor 220 may perform mapping based on such correspondences. Specifically, it is created a map including information indicative of which inspection light receiving element actually receives the detecting light L1 that was originally emitted toward a specific inspection light receiving element, as well as information indicative of which inspection light receiving element receives the detecting light L1 the amount of light of which has been reduced.

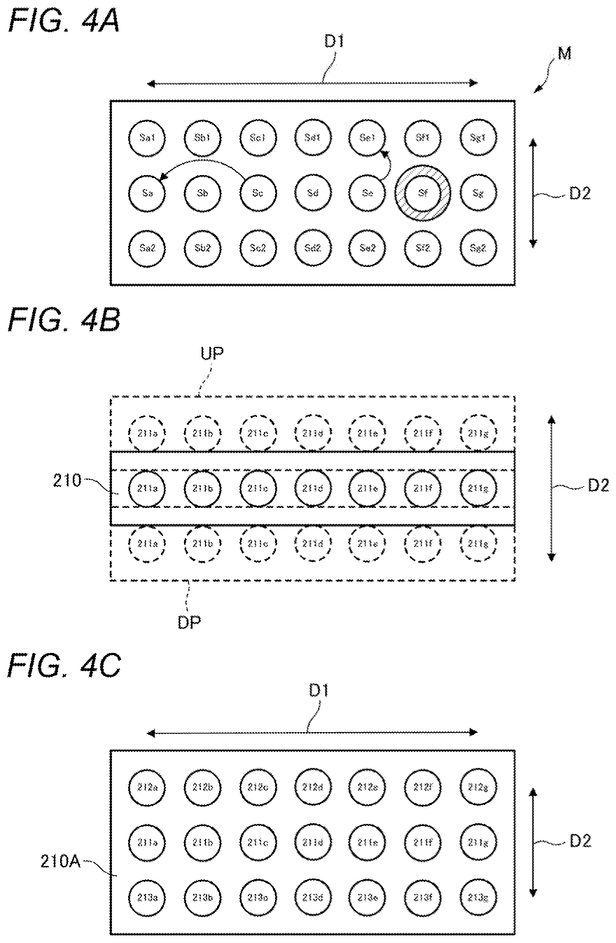

FIG. 4A illustrates a map M to he created. The map M induces seven sites Sa to Sg, arranged in a direction corresponding to the first direction D1. These are associated with the seven inspection light receiving elements 211a to 211g.

In the example illustrated in FIG. 2, the detecting light L1 emitted in the direction indicated by the symbol L1a is normally incident on the inspection light receiving element 211a. In the map M, the site Sa corresponds to the inspection light receiving element 211a. The site Sa does not include information indicating an abnormality.

Similarly, the detecting light L1 emitted in the direction indicated by the symbol L1b is normally incident on the inspection light receiving element 211b. The detecting light L1 emitted in the direction indicated by the symbol L1d is normally incident on the inspection light receiving element 211d. The detecting light L1 emitted in the direction indicated by the symbol L1g is normally incident on the inspection light receiving element 211g. In the map M, the site Sb, the site Sd, and the site Sg correspond to the inspection light receiving element 211b, the inspection light receiving element 211d, and the inspection light receiving element 211g, respectively. Each of the site Sb, the site Sd, and the site Sg does not include information indicating an abnormality.

In the example illustrated in FIG. 2, the detecting light L1 emitted in the direction indicated by the symbol L1c is incident on the inspection light receiving, element 211a due to abnormal refraction. In the map M, the site Sc corresponds to the inspection light receiving element 211c. The site Sc includes abnormality information associated with the site Sa. The information indicates that the detecting light L1 emitted toward the inspection light receiving element 211c is incident on the inspection light receiving element 211a. That is, the information indicates that a portion of the translucent cover 120 through which the detecting light L1 emitted in the direction indicated by the symbol L1e passes has an abnormality that refracts the detecting light L1 in the direction toward the inspection light receiving element 211a.

In the example illustrated in FIG. 2, the detecting light L1 emitted in the direction indicated by the symbol L1f is incident on the inspection light receiving element 211f in a state where the amount of light is reduced. In the map M, the site Sf corresponds to the inspection light receiving element 211f. The site Sf includes abnormality information related to the reduction in the amount of light. The information indicates that the amount of detecting light L1 emitted toward the inspection light receiving element 211f is reduced. That is, the information indicates that a portion of the translucent cover 120 through which the detecting light L1 emitted in the direction indicated by the symbol L1f passes has an abnormality that reduces the amount of light of the detecting light L1.

The inspection processor 220 determines whether the mapping has been completed for all the inspection light receiving elements 211a to 211g (STEP6 in FIG. 3).

In the example illustrated in FIG. 2, the detecting light L1 emitted in the direction indicated by the symbol L1e passes over the inspection light receiving element 211e due to abnormal refraction. That is, the light is incident on none of the seven inspection light receiving elements 211a to 211g. Accordingly, information as to the direction of the abnormally refracted detecting light L1 is not obtained, so that the mapping is not completed (N in STEP6).

In this case, the inspection processor 220 executes a reinspection (STEP7). Specifically, as illustrated in FIG. 4B, the position of the light receiving device 210 is changed upward or downward along the second direction D2. The symbol UP represents the position of the light receiving device 210 moved upward. A symbol LP represents the position of the light receiving device 210 moved downward. The movement of the light receiving device 210 may be performed by an actuator (not illustrated) controlled by the inspection processor 220, or may be performed manually.

Subsequently; the inspection processor 220 causes the light emitting element 111 to emit the detecting light L1 toward the initial position of the inspection light receiving element 211e. The detecting light L1 emitted in the direction indicated by the symbol L1e in FIG. 2 is refracted upward by the translucent cover 120 and incident on the inspection light receiving element 211e located at the position indicated by the symbol UP.

The map M illustrated in FIG. 4A further includes seven sites Sa1 to Sg1 arranged in a direction corresponding to the first direction D1. The seven sites Sa1 to Sg1 are arranged so as to be aligned with the seven sites Sa to Sg in a direction corresponding to the second direction D2. The second direction D2 is, for example, a direction corresponding to the up-down direction of the vehicle. The seven sites Sa1 to Sg1 are located above the seven sites Sa to Sg. The seven sites Sa1 to Sg1 correspond to the seven inspection light receiving elements 211a to 211g located at positions indicated by symbol UP.

The map M further includes seven sites Sa2 to Sg2 arranged in a direction corresponding to the first direction D1. The seven sites Sa2 to Sg2 are arranged so as to be aligned with the seven sites Sa to Sg in a direction corresponding to the second direction D2. The seven sites Sa2 to Sg2 are located below the seven sites Sa to Sg. The seven sites Sa2 to Sg2 correspond to the seven inspection light receiving elements 211a to 211g located at positions indicated by symbol LP.

That is, in the map M, the site Se corresponds to the inspection light receiving element 211e, and the site Se1 corresponds to the inspection light receiving element 211e located at the position indicated by the symbol UP. The site Se includes abnormality information associated with the site Se1. The information indicates that the detecting light L1 emitted toward the inspection light receiving element 211e is incident on the inspection light receiving element 211e at the position indicated by the symbol UP. That is, the information indicates that a portion of the translucent cover 120 through which the detecting light L1 emitted in the direction indicated by the symbol L1e passes has an abnormality that refracts the detecting light L1 in the direction toward the inspection light receiving element 211e indicated by the symbol UP.

The processing returns to STEP6, and the inspection processor 220 determines whether the mapping is completed as a result of the reinspection. In this example, the mapping is completed by the upward movement of the light receiving device 210 (Y in STEP6). Accordingly, the processing proceeds to STEP5, and the inspection processor 220 outputs a determination result R indicating that there is an abnormality in the translucent cover 120.

For example, when the detecting light L1 is not incident on any of the inspection light receiving elements even if the light receiving device 210 is moved upward, the mapping is not completed (N in STEP6). In this case, the position of the light receiving device 210 is changed to the position indicated by the symbol LP. Alternatively, the light receiving device 210 may be moved further upward. Such a positional change of the inspection light receiving elements is repeated until the mapping is completed.

According to such a configuration, even in a case where the traveling direction of the detecting light L1 refracted by the abnormality of the translucent cover 120 extends over a wider range, it is possible to obtain information as to the abnormality of the translucent cover 120.

In order to enable the reception of the refracted detecting light L1 over a wider range, a light receiving device 210A as illustrated in FIG. 4C may be used. In the light receiving device 210A, a plurality of inspection light receiving elements are two-dimensionally arranged.

Specifically, the light receiving device 210A further includes seven inspection light receiving elements 212a to 212g arranged in the first direction D1. The seven inspection light receiving elements 212a to 212g are arranged so as to be aligned with the seven inspection light receiving elements 211a to 211g in the second direction D2. The seven inspection light receiving elements 212a to 212g are located above the seven inspection light receiving elements 211a to 211g. The seven sites Sa1 to Sg1 illustrated in FIG. 4A correspond to the seven inspection light receiving elements 212a to 212g.

The light receiving device 210A further includes seven inspection light receiving elements 213a to 213g arranged in the first direction D1. The seven inspection light receiving elements 213a to 213g are arranged so as to be aligned with the seven inspection light receiving elements 211a to 211g in the second direction D2. The seven inspection light receiving elements 213a to 213g are located below the seven inspection light receiving elements 211a to 211g. The seven sites Sa2 to Sg2 illustrated in FIG. 4A correspond to the seven inspection light receiving elements 213a to 213g.

The scanning mechanism 113 of the sensor system 100 may be configured to change the emitting direction of the detecting light L1 not only in the first direction D1 but also in the second direction D2. According to the light receiving device 210A as described above, it is also possible to easily cope with a sensor system in which the detecting light L1 is scanned two-dimensionally in this manner.

As illustrated in FIG. 3, when the determination result R indicates the presence of an abnormality in the translucent cover 120, the inspection processor 220 may output data for correcting the detected result obtained by the sensor system 100 (STEP8). The data may be generated on the basis of the map M.

In the example illustrated in FIG. 4A, the map M indicates that the detecting light L1 emitted in the direction corresponding to the inspection light receiving element 211c is directed to the position of the inspection light receiving element 211a. In this case, the information detected by the reflected light L2 generated on the basis of the detecting light L1 is not associated with an object that situates in the direction corresponding to the inspection light receiving element 211c, but is associated with an object that situates in the direction corresponding to the inspection light receiving element 211a. Examples of the correction of such a detected result may include no employment of the detected result based on the detecting light L1 emitted in the direction corresponding to the inspection light receiving element 211c.

In this example, the map M indicates that the detecting light L1 emitted in the direction corresponding to the inspection light receiving element 211e is directed to an upper position. In this case, the information detected by the reflected light L2 generated on the basis of the detecting light L1 is not associated with an object that situates in the direction corresponding, to the inspection light receiving element 211e, but is associated with an object that situates above the inspection light receiving element 211e. Examples of the correction of such a detected result may include handling of the detected result based on the detecting light L1 emitted in the direction corresponding to the inspection light receiving element 211e as a detected result obtained from a higher position.

In this example, the map M indicates that the amount of light of the detecting light L1 emitted in the direction corresponding to the inspection light receiving element 211f is reduced. In this case, the amount of light of the reflected light L2 generated on the basis of the detecting light L1 is also reduced. Examples of correction of such a detected result may include amplifying the light receiving signal S1 outputted from the light receiving element 112 based on the reflected light L2 generated by the detecting light L1 emitted in the direction corresponding to the inspection light receiving element 211f.

According to such a configuration, even when an abnormality is sensed in the translucent cover 120 that allows the passage of the detecting light L1 emitted from the light emitting element 111, it is possible to suppress degradation in the information detecting accuracy of the sensor system 100 without replacing or repairing the translucent cover 120.

The above embodiments are mere examples for facilitating understanding of the presently disclosed subject matter. The configuration according to each of the above embodiments can be appropriately modified without departing from the gist of the presently disclosed subject matter.

The LiDAR sensor unit 110 of the sensor system 100 may be replaced with an appropriate sensor unit including a fight emitting element, a light receiving element, and a scanning mechanism. Examples of such a sensor unit include a TOF (Time of Flight) camera unit and a millimeter wave sensor unit. The wavelength of the detecting light emitted by the light emitting element and the wavelength at which the light receiving element has sensitivity can be appropriately determined according to the detection technique used.

The present application is based on Japanese Patent Application No. 2018-134898 filed on Jul. 18, 2018, the entire contents of which are incorporated herein by reference.

1. An inspection device for a sensor system equipped with a light emitting element that emits detecting light, a translucent cover that allows passage of the detecting light, and a scanning mechanism that changes an emitting direction of the detecting light at least in a first direction, the inspection device comprising:
a light receiving device equipped with a plurality of inspection light receiving elements arranged at least along the first direction, and adapted to be disposed on an optical path of the detecting light that has passed through the translucent cover; and
a processor configured to output a determination result as to whether an abnormality is present in the translucent cover on the basis of a determination as to whether each of the inspection light receiving elements has normally received the detecting light.

2. The inspection device according to claim 1,
wherein the processor is configured to output the determination result on the basis of a relationship between the emitting direction of the detecting light and a position where the detecting light is received at the light receiving device.

3. The inspection device according to claim 2,
wherein the processor is configured to, in a case where none of the inspection light receiving elements receives the detecting light emitted toward one of the inspection light receiving elements, cause the light emitting element to emit the detecting light again after a position of the light receiving device is changed.

4. The inspection device according to claim 2,
wherein the processor is configured to, in a case where the determination result indicates that an abnormality is present in the translucent cover, output data for correcting a detected result obtained by the sensor system.

5. The inspection device according to claim 1,
wherein the inspection light receiving elements are arranged two-dimensionally.

6. An inspection method for a sensor system equipped with a light emitting element that emits detecting light, a translucent cover that allows passage of the detecting light, and a scanning mechanism that changes an emitting direction of the detecting light at least in a first direction, the inspection method comprising:
disposing a light receiving device equipped with a plurality of inspection light receiving elements arranged at least along the first direction on an optical path of the detecting light that has passed through the translucent cover;
causing the light emitting element to emit the detecting light;
causing the scanning mechanism to scan the detecting light at least in the first direction; and
outputting a determination result as to whether an abnormality is present in the translucent cover on the basis of a determination as to whether each of the inspection light receiving elements has normally received the detecting light.
